(19) United States
(12) Patent Application Publication
(10) Pub. No.: US 2014/0279390 A1
(43) Pub. Date: Sep. 18, 2014

(54) METHOD AND SYSTEM FOR DETERMINING AN ONLINE LOAN

(71) Applicant: WONGA TECHNOLOGY LIMITED, Dublin (IE)

(72) Inventors: Errol Damelin, London (GB); Daniel Hegarty, London (GB); Jonty Hurwitz, London (GB)

(21) Appl. No.: 13/840,860

(22) Filed: Mar. 15, 2013

(51) Int. Cl. G06Q 40/02

(52) U.S. Cl. CPC G06Q 40/025
USPC 705/38

(57) ABSTRACT

A computer system includes a processor, memory and one or more inputs. The computer system is programmed to carry out the following process. Data identifying a user applying for an on-line loan is received. A trust rating is determined as a function of the data identifying the user. Data is provided to a user device to present to the user a graphical control having a lower level, an upper level and a pointer moveable between the lower level and the upper level. The computer system selects the upper level as a function of the trust rating. Data is received specifying one or more selections made by the user on the graphical control including the final position of the pointer. A determination is made whether to provide a loan as a function of the data specifying the selections made by the user.

### BACKGROUND OF THE INVENTION

The present disclosure relates to systems and methods for determining whether to provide an online loan to a user.

There are known systems and methods for determining whether to provide a loan to a user. Examples include systems which retrieve some form of credit rating and use this in determining whether to provide a loan. Such systems also include security controls to ensure that an applicant for an online loan, for example, is genuinely the person they purport to be. Generally, these known systems require some independent channel of communication other than between the user and the online loan provider. What is needed, therefore, is a system that determines whether to provide an online loan to a user without the need for an independent channel of communication other than between the user and the online loan provider.

### SUMMARY OF THE INVENTION

In one form, the present disclosure provides a computer system for determining whether to provide an online loan to a user. The computer system includes a processor, memory and one or more inputs, the computer system being programmed to carry out the following process: receiving data identifying a user applying for an online loan; determining a trust rating as a function of the data identifying the user; providing data to a user device to present to the user a graphical control having a lower level, an upper level and a pointer moveable between the lower level and the upper level, the computer system selecting the upper level as a function of the trust rating; receiving data specifying one or more selections made by the user on the graphical control including a final position of the pointer; and determining whether to provide the online loan as a function of the data specifying the selections made by the user. In another form, the present disclosure provides a method for determining whether to provide an online loan to a user. The method includes receiving data identifying a user applying for an online loan; determining a trust rating as a function of the data identifying the user; providing data to a user device to present to the user a graphical control having a lower level, an upper level and a pointer moveable between the lower level and the upper level, the upper level selected as a function of the trust rating; receiving data specifying one or more selections made by the user on the graphical control including a final position of the pointer; and determining whether to provide the online loan as a function of the data specifying the selections made by the user.

In another form, the present disclosure provides a method for determining whether to provide an online loan to a user. The method includes transmitting a plug-in to a remote user device, the plug-in being a computer program, which when stored in a memory of the remote user device, will cause the remote user device to: transmit data identifying a user applying for an online loan; present to the user a graphical control having a lower level, an upper level and a pointer moveable between the lower level and the upper level, the upper level being selected as a function of a trust rating; transmit data specifying one or more selections made by the user on the graphical control including a final position of the pointer; and determining whether to provide the online loan as a function of the data specifying the selections made by the user.

Additionally, a system or method in accordance with the present disclosure can determine a measure of confidence for a user applying for an online loan.

Further areas of applicability of the present disclosure will become apparent from the detailed description provided hereinafter. It should be understood that the detailed description, including disclosed embodiments and drawings, are merely exemplary in nature intended for purposes of illustration only and are not intended to limit the scope of the invention, its application or use. Thus, variations that do not depart from the gist of the invention are intended to be within the scope of the invention.

### BRIEF DESCRIPTION OF THE DRAWINGS

The invention will now be described in more detail by way of example with reference to the drawings, in which:

FIG. 1: is a schematic diagram of a system embodying the invention;

FIGS. 2a-2c: show exemplary graphical controls;

FIG. 3: is a flow diagram showing a method embodying the invention, and

FIGS. 4a and 4b: are further examples of graphical controls.

### DETAILED DESCRIPTION OF THE PREFERRED EMBODIMENTS

In one form, the present disclosure provides an online loan system that receives input from a user prior to determining whether to provide a loan. This embodiment is particularly applicable to online loan systems requiring a rapid measure of acceptability of a user in determining whether to provide a loan, but without requiring additional data exchange outside the online loan system. An online loan system may be any system with which a user remotely seeks to communicate by wired, wireless or other connection for the purpose of requesting a loan.

The determination as to whether to provide a loan as part of a user's online request must not be unduly delayed. As a certain amount of time is required for retrieval and analysis, the call to the function to determine whether to provide a loan should be made as early as possible so that it can run in the background and be ready once a user reaches the relevant part of the online system.

The measure of acceptability of a user in determining whether to provide an online loan may be calculated in many different ways. For example the measure of acceptability may be a simple scalar value, such as a value from 1 to 10, or the measure of acceptability may be a more complex value, such as a vector.

In one embodiment, the present disclosure provides a system such that a user is presented with a graphical display having a slider with a lower level, an upper level and a pointer moveable between the lower level and the upper level. The slider may indicate a parameter for a variety of choices, such as an input of a user related value, a time period, a date or other value that the user may select. The pointer is set to an initial value between the lower level and the upper level of the slider. The upper level may be determined by the system in accordance with a trust rating. A measure of confidence for the user may be determined based on the initial position of the pointer, the upper level of the slider, and any subsequent movement of the pointer by the user. The measure of confidence can be used in the determination of whether to provide the user with an online loan.

FIG. 1 is a diagram of the main functional components of a system 1 in accordance with the present disclosure. It is to be understood that each of these components may comprise separate hardware or software modules, some of which may be combined. The modules are described separately for ease of understanding.

A user data input module 2 may be at a client device such as a PC, mobile telephone, tablet or any suitable device connected to the system 1 via wired or wireless connection such as the Internet. The user data input module may comprise one or more of a touch screen, mouse, keyboard, voice recognition or other control.

An input 4 receives data identifying the user such as a username, user-id (if the user is a prior user of the system) and any other suitable user related data from the client device. The data identifying the user is provided to a trust rating determination module 6. The trust module 6 calculates an initial value indicating the level to which the user is trusted. For example, a new user is given a low trust value, while a user that frequently uses the system and has already proven to be a reliable user will be given a higher trust rating. Further details of determining initial trust ratings are given later.

Once determined, the trust rating is provided to a graphical control presentation module 8 for determining an appropriate graphical display to present to the user. The graphical display includes a slider based on the initial trust rating. The slider will have a lower level for an online loan, an upper level for an online loan, and any number of possible positions between the upper level and the lower level for a moveable indicator, here referred to as a pointer. The graphical control presentation module 8 determines an appropriate upper level and optionally the initial position for the pointer based on the trust rating for the user. One approach is to place the initial position of the pointer closer to the upper level as the user's trust rating increases. Another approach is to vary the upper level, but fix the initial position of the pointer at a position for all users, such as at an offset from the center between the lower level and upper level.

The graphical control presentation module 8 provides an output to a display 11 on which the graphical control is presented to a user. A user input 12 is provided by which a user may manipulate the graphical control to select a loan value or values on the slider. The user input 12 may be one or more of a touch screen, mouse, keyboard, voice recognition or other control. The user data input 2, the display 11 and the user input 12 may be combined as a single touchscreen device such as a smart phone or tablet computer, or may be separate such as a separate display, mouse and keyboard connected to a personal computer.

The user may select a value on the display using the pointer via a user input 12 which provides this value to the confidence calculation module 10. The confidence calculation module calculates a confidence value as a function of the initial position of the pointer and the user's movement of the pointer. The confidence value is used in the determination of whether to provide the user with the online loan. The confidence value may be asserted as an output signal on an output line 13 to control other systems to provide the loan to the user as well as providing a signal back to the user device for display on the display 11.

FIG. 2 shows exemplary graphical displays presented to a user in accordance with the present disclosure. The graphical displays may include a slider, which the user can manipulate by moving the position of a pointer. FIG. 2a shows a single slider 20 arrangement allowing a user to select a single value between a lower level 21 and an upper level 22 using a pointer 24. The upper level is determined according to a trust rating as previously described. In one example, a user that has previously used the system is provided with a high trust value, so the upper level 22 may be high. However, if the user immediately selects the maximum value of access required each time the user logs into the system, this behaviour could actually reduce the amount of access the user is given. As another example, if the user selects a lower value of access required, then this may demonstrate a more considered approach by the user and allow a higher level of confidence to be calculated and greater access given. As previously noted, the confidence value may be used to allow access to an amount of material or could be used for other purposes such as allowing an amount of bandwidth online or other such purposes.

FIG. 2b is a similar arrangement to FIG. 2a and shows multiple sliders with like components labelled as in FIG. 2a. In this arrangement, each slider may represent different types of entry. For example, each slider may represent a period of time that a user may enter in response to a question. The confidence value may be based on the values provided.

FIG. 2c is a rotary version of the sliders of FIG. 2b, and shows a pointer 24 between a lower level 21 and an upper level 22. In each of the exemplary embodiments shown in FIG. 2, a user has the ability to enter one or more values using a pointer, or indicator, along a scale to provide either an exact or an approximate value between the upper and lower levels.

FIG. 3 shows a process in accordance with the present disclosure that may be operable at a client device or at a server. At receiving step 30, data is received identifying a user. At step 31, a determination is made as to whether the user is a new user. If so, a default trust rating is retrieved at step 36. If the user is not a new user, then user's trust rating is retrieved at step 32. The retrieved trust rating is used as the basis for presenting sliders on screen at step 33. At step 34, the selections made by a user are received and at step 35 a confidence calculation is made as a function of user's manipulation of the slider.

FIG. 4 shows graphical control displays in accordance with the present disclosure. FIG. 4a shows an example graphical control based on a low trust rating for a user. Users may be classified as L0 customers that have not borrowed using the online system before and LN customers that have used the system at least once before. FIG. 4a shows a slider arrangement for an L0 customer. As can be seen, the slider arrangement allows the user to choose how much they wish to borrow for the loan between 0 and a maximum amount, or upper limit, here the maximum being £400 for the L0 customer. Such an L0 customer has a low trust rating or a default trust rating provided by the system. The user can move the slider on the display to select a variable amount of money to borrow. The minimum value, or lower limit, is a system wide setting, here £1, while the maximum value is determined according to the trust rating as already described. A customer may choose to drag the slider from the minimum to the maximum and any point in between. The default position of the slider is an offset position from the center between the minimum and the maximum. The slider may have a step size of small or large increments, depending upon the use of the system.

FIG. 4b shows a slider arrangement for a so called LN customer, namely a user that has used the online loan system before. As can be seen, the maximum value available for the loan is set at a higher value. As before, the user has the option of selecting a value to borrow between £1 and the maximum value, here £900.

In both the examples of FIGS. 4a and 4b, the user makes a selection on the slider for how much they want to borrow and for how long. The online loan system determines whether to provide a loan, or to whether make a counter offer for a smaller amount, based on both the amount actually selected by the user and the manner in which they moved the slider from the starting position to the final position selected. As previously noted, if the user simply puts the slider straight to the maximum value, this indicates one type of behaviour which may mean the loan has a lower likelihood of being repaid. On the other hand, if a user moves a slider many times up and down between the minimum and maximum before finally settling on an amount, this may indicate that they are indecisive and also would have a low chance of repaying the loan. This behavioural information is captured by the system and used as part of the loan determining process.

With the above, an effective method for determining whether to provide a user an online loan is provided.

What is claimed is:

1. A computer system comprising a processor, memory and one or more inputs, the computer system being programmed to carry out the following process:
receiving data identifying a user applying for an online loan;
determining a trust rating as a function of the data identifying the user;
providing data to a user device to present to the user a graphical control having a lower level, an upper level and a pointer moveable between the lower level and the upper level, the computer system selecting the upper level as a function of the trust rating;
receiving data specifying one or more selections made by the user on the graphical control including a final position of the pointer; and
determining whether to provide the online loan as a function of the data specifying the selections made by the user.

2. The computer system of claim 1, further programmed to determine whether to provide the loan as a function of the data specifying the selections made by the user and one or more additional factors.

3. The computer system of claim 1, further programmed to retrieve the trust rating based on the data identifying the user.

4. The computer system of claim 1, further programmed to retrieve a default trust rating if the data identifying the user specifies that the user is a new user of the system.

5. The computer system of claim 1, further programmed to calculate a measure of confidence of the user as a function of the data specifying the selections made by the user.

6. A method for determining whether to provide an online loan, comprising:
receiving data identifying a user applying for an online loan;
determining a trust rating as a function of the data identifying the user;
providing data to a user device to present to the user a graphical control having a lower level, an upper level and a pointer moveable between the lower level and the upper level, the upper level selected as a function of the trust rating;
receiving data specifying one or more selections made by the user on the graphical control including a final position of the pointer; and
determining whether to provide the online loan as a function of the data specifying the selections made by the user.

7. The method of claim 6, further comprising determining whether to provide the loan as a function of the data specifying the selections made by the user and one or more additional factors.

8. The method of claim 6, further comprising retrieving the trust rating based on the data identifying the user.

9. The method of claim 6, further comprising retrieving a default trust rating if the data identifying the user specifies that the user is a new user of the system.

10. The method of claim 6, further comprising calculating a measure of confidence of the user as a function of the data specifying the selections made by the user.

11. A method for determining whether to provide an online loan, comprising:
transmitting a plug-in to a remote user device, the plug-in being a computer program, which when stored in a memory of the remote user device, will cause the remote user device to:
transmit data identifying a user applying for an online loan;
present to the user a graphical control having a lower level, an upper level and a pointer moveable between the lower level and the upper level, the upper level being selected as a function of a trust rating;
transmit data specifying one or more selections made by the user on the graphical control including a final position of the pointer; and
determining whether to provide the online loan as a function of the data specifying the selections made by the user.

12. The method of claim 11, further comprising determining whether to provide the loan as a function of the data specifying the selections made by the user and one or more further factors.

13. The method of claim 11, further comprising retrieving the trust rating based on the data identifying the user.

14. The method of claim 11, further comprising retrieving a default trust rating if the data identifying the user specifies that the user is a new user of the system.

15. The method of claim 11, further comprising calculating a measure of confidence of the user as a function of the data specifying the selections made by the user.
